(19) United States
(12) Patent Application Publication
(10) Pub. No.: US 2016/0366616 A1
(43) Pub. Date: Dec. 15, 2016

(54) FLOW CONTROL METHOD AND APPARATUS FOR MENB AND SENB

(71) Applicant: ALCATEL LUCENT, Boulogne-Billancourt (FR)

(72) Inventors: Pingping Wen, Shanghai (CN); Chandrika Worrall, Newbury (GB); Yun Deng, Shanghai (CN)

(73) Assignee: Alcatel Lucent, Boulogne Billancourt (FR)

(21) Appl. No.: 15/114,203

(22) PCT Filed: Jan. 14, 2015
(86) PCT No.: PCT/IB2015/000238

§ 371 Date: Jul. 26, 2016

(30) Foreign Application Priority Data
Jan. 28, 2014 (CN) 201410042687.5

(51) Int. Cl. H04W 28/10; H04W 28/02

(52) U.S. Cl. CPC H04W 28/10; H04W 28/0231; H04W 28/0278; H04W 88/08

(57) ABSTRACT

Embodiments of the present invention disclose a flow control method and apparatus for an MeNB and an SeNB supporting radio bearer split in a dual connectivity system. The method comprises: receiving information related to an SeNB; and performing flow control with the SeNB based on the information and information related to the MeNB. Through the embodiments of the present invention, the flow control not only considers performing flow control according to middle-and-long terms channel and load conditions, but also cause the flow control to consider the rapid change of the channel and load through feeding back the transmission/service state.

### TECHNICAL FIELD

Embodiments of the present invention generally relate to the field of communication, and more specifically, relates to a flow control method and apparatus for a Master Evolved NodeB (MeNB) and a Secondary Evolved NodeB (SeNB), both supporting radio bearer split, in a dual-connectivity system.

### BACKGROUND

Currently, dual connectivity is an important topic being studies and developed in 3GPP RAN (Third Generation Partnership Project Radio Access Network). The dual connectivity provides a good mobility performance by connection to a macro cell and splits traffic by connection to a small cell. 9 candidate user plane architectures have been proposed, but only two user plane architectures are agreed now, i.e., 1A and 3C specified below:

1A: S1-U (subscriber plane protocol stack) terminates in the SeNB+independent packet data convergence protocol (PDCP)s, no radio bearer split;

3C: S1-U terminates in the MeNB+radio bearer split in the MeNB+independent RLCs for splitting radio bearers.

FIG. 1 schematically shows a user plane architecture 3C according to relevant art, wherein the downlink direction is used as an example. As shown in FIG. 1, the user plane architecture 3C supposes that S1-U terminates in MeNB, wherein the PDCP layer resides in the MeNB. Besides, the user plane architecture 3C supports radio bearer split in RAN, i.e., data belonging to a bearer may be simultaneously transmitted through MeNB and SeNB.

In the case of radio bearer split, flow control is needed between the MeNB and the SeNB. The flow control is a key function, which will determine how to split data between the two eNBs for the subscriber. How to perform flow control has a direct impact on the performance (such as throughput and delay) of the subscriber on the bearer. However, how to perform flow control is not proposed during the process of determining that the subscriber plane control architecture 3C should be adopted.

### SUMMARY

In view that how to perform flow control is not proposed during the process of determining that the subscriber plane control architecture 3C should be adopted in 3GPP, the embodiments of the present invention provide a flow control method, apparatus, and system for supporting radio bearer split in a dual-connectivity system.

According to one aspect of the embodiments of the present invention, there is provided a flow control method for an MeNB supporting radio bearer split in a dual-connectivity system, comprising: receiving information related to an SeNB; and performing flow control with the SeNB based on the information and information related to the MeNB.

In one embodiment, receiving information related to an SeNB comprises: receiving information for performing basic flow control to the SeNB.

In one embodiment, receiving information for performing basic flow control to the SeNB comprises: receiving at least one of load condition, channel condition, and CQI of the SeNB from the SeNB, and/or receiving channel condition and/or CQI of the SeNB from a UE.

In one embodiment, the load condition of the SeNB includes a load condition of the SeNB with respect to a split RB of interest.

In one embodiment, the channel condition includes RSRP.

In one embodiment, there further includes: triggering the SeNB and/or the UE to transmit the information based on event trigger or time trigger.

In another embodiment, receiving information related to an SeNB further comprises: receiving a buffer state of a buffer of the SeNB with respect to a RB or RB set of interest.

In one embodiment, performing flow control with the SeNB based on the information and information related to the MeNB comprises: increasing, reducing, or stopping allocating, to the SeNB, data volume transmitted by the SeNB based on the buffer state.

In another embodiment, receiving information related to an SeNB further comprises: receiving first indication information, wherein the first indication information is for indicating a service state of the SeNB for a RB or RB set of a split supported between the MeNB and the SeNB.

In one embodiment, there further comprises: receiving a second indication information, wherein the second indication information is for indicating whether the first indication information exists.

In one embodiment, both of the first indication information and the second indication information are 1 bit.

In one embodiment, the first indication information is 2 bits, for indicating at least one of increasing the data volume allocated to the SeNB for transmission by the SeNB, reducing the data volume allocated to the SeNB for transmission by the SeNB, stopping allocating the data volume for transmission by the SeNB, and not adjusting the data volume allocated to the SeNB for transmission by the SeNB.

In one embodiment, if the service state indicates the SeNB transmits data at a data rate higher than what is expected, performing flow control with the SeNB based on the information and information related to the MeNB comprises: increasing the data volume allocated to the SeNB for transmission by the SeNB based on the first indication information; if the service state indicates the SeNB transmits data at a data rate lower than what is expected, performing flow control with the SeNB based on the information and information related to the MeNB comprises: reducing the data volume allocated to the SeNB for transmission by the SeNB or stopping allocating the data volume for transmission by the SeNB based on the first indication information.

In a further embodiment, receiving information related to an SeNB further comprises: receiving a throughput in the SeNB provided by the RB or RB set supported between the MeNB and the SeNB.

In one embodiment, performing flow control with the SeNB based on the information and information related to the MeNB comprises: allocating, to the SeNB, a data volume for transmission by the SeNB based on the information and the throughput.

In one embodiment, the information related to the MeNB includes: load condition and/or buffer state of the MeNB collected by the MeNB itself; and/or channel condition and/or CQI of the MeNB received by the MeNB from the UE.

According to another aspect of the embodiments of the present invention, there is provided a flow control method for a SeNB supporting radio bearer split in the dual-connectivity system, comprising: transmitting information related to the SeNB to an MeNB; and receiving data transmitted by the MeNB to the SeNB through a flow control decision.

In one embodiment, transmitting information related to the SeNB to an MeNB comprises: transmitting, to the MeNB, information for performing basic flow control to the SeNB.

In one embodiment, the information for performing basic flow control to the SeNB includes: at least one of load condition, channel condition, and channel condition indicator CQI of the SeNB.

In one embodiment, the load condition of the SeNB includes a load condition of a split RB in which the SeNB is interested, and the channel condition includes RSRP.

In another embodiment, transmitting information related to the SeNB to an MeNB further comprises: transmitting, to the MeNB, a buffer state of a buffer of the SeNB with respect to a RB or RB set of interest.

In one embodiment, transmitting, to the MeNB, a buffer state comprises: periodically transmitting a buffer state to the MeNB.

In one embodiment, transmitting, to the MeNB, a buffer state comprises: transmitting, to the MeNB, a buffer state when the data volume buffered by the buffer is lower than a preset first threshold or higher than a preset second threshold.

In one embodiment, transmitting, to the MeNB, a buffer state comprises: transmitting, to the MeNB, a buffer state using BSR.

In one embodiment, transmitting, to the MeNB, a buffer state using BSR comprises: if only one radio bearer RB or RB set is supported between the MeNB and the SeNB, a buffer state is transmitted to the MeNB using a 1-byte BSR, wherein the 1-byte BSR includes a 2-bit LGG ID and 6-bit buffer size corresponding to the RB or RB set.

In one embodiment, transmitting, to the MeNB, a buffer state using BSR comprises: if a plurality of Rbs or RB sets are supported between the MeNB and the SeNB, transmitting, to the MeNB, the buffer state using a long BSR, wherein the long BSR comprises consecutively stored buffer sizes corresponding to the plurality of RBs or RB sets, respectively, and a padding bit at a tail of the long BSR.

In one embodiment, transmitting, to the MeNB, a buffer state using BSR comprises: if four RBs or RB sets are supported between the MeNB and the SeNB, transmitting, to the MeNB, a buffer state using a three-byte BSR, wherein the three-byte BSR includes consecutively stored buffer sizes corresponding to the four RBs or RB sets, respectively.

In one embodiment, there further comprises: indicating whether to transmit the BSR using LGG ID or additional 1 bit.

In a further embodiment, transmitting information related to the SeNB to an MeNB further comprises: transmitting first indication information to the MeNB, wherein the first indication information is for indicating a service state of the SeNB with respect to a RB or RB set supported between the MeNB and the SeNB.

In one embodiment, there further comprises: transmitting second indication information to the MeNB, wherein the second indication information is for indicating whether the first indication information exists.

In one embodiment, both of the first indication information and the second indication information are 1 bit.

In one embodiment, the first indication information is 2 bits, for indicating at least one of increasing the data volume allocated to the SeNB for transmission by the SeNB, reducing the data volume allocated to the SeNB for transmission by the SeNB, stopping allocating the data volume for transmission by the SeNB, and not adjusting the data volume allocated to the SeNB for transmission by the SeNB.

In a further embodiment, transmitting information related to an SeNB further comprises: transmitting, to the MeNB, a throughput in the SeNB provided by the RB or RB set supported between the MeNB and the SeNB.

According to a further aspect of the embodiments of the present invention, there is further provides a flow control device of an MeNB supporting radio bearer split in a dual connectivity system, comprising: a receiving module configured to receive information related to an SeNB; and a performing module configured to perform flow control with the SeNB based on the information and information related to the MeNB.

In one embodiment, the receiving module receives information for performing basic flow control to the SeNB.

In one embodiment, the receiving module receives, from the SeNB, at least one of load condition, channel condition, and CQI of the SeNB from the SeNB, and/or receives channel condition and/or CQI of the SeNB from a UE.

In one embodiment, the load condition of the SeNB includes a load condition of the SeNB with respect to a split RB of interest.

In one embodiment, the channel condition includes RSRP.

In one embodiment, the information related to the MeNB includes: load condition and/or buffer state of the MeNB collected by the MeNB itself; and/or channel condition and/or CQI of the MeNB received by the MeNB from the UE.

According to a still further aspect of the embodiments of the present invention, there is further provided a flow control device for a SeNB supporting radio bearer split in the dual-connectivity system, comprising: a transmitting module configured to transmit information related to the SeNB to an MeNB; and a receiving module configured to receive data transmitted by the MeNB to the SeNB through a flow control decision.

According to a yet further aspect of the embodiments of the present invention, there is further provided a computer program product including thereon computer program instructions that may perform the above various aspects.

### DESCRIPTION OF DRAWINGS

The above and other objectives, features, and advantages of the embodiments of the present invention will become more apparent through reading the detailed description below with reference to the accompanying drawings. In the drawings, several embodiments of the present invention are illustrated in an exemplary, non-limiting manner, wherein:

FIG. 1 shows a user plane architecture 3C according to a relevant art;

FIG. 2 shows a schematic diagram of a flow control system according to the embodiments of the present invention;

FIG. 3 shows a flow diagram of a flow control method for an MeNB supporting radio bearer split in a dual-connectivity system according to the embodiments of the present invention;

FIG. 4 shows a flow diagram of a flow control method for an SeNB supporting radio bearer split in a dual-connectivity system according to the embodiments of the present invention;

FIG. 5 is a first diagram of BSR according to the embodiments of the present invention;

FIG. 6 is a second diagram of BSR according to the embodiments of the present invention;

FIG. 7 is a third diagram of BSR according to the embodiments of the present invention;

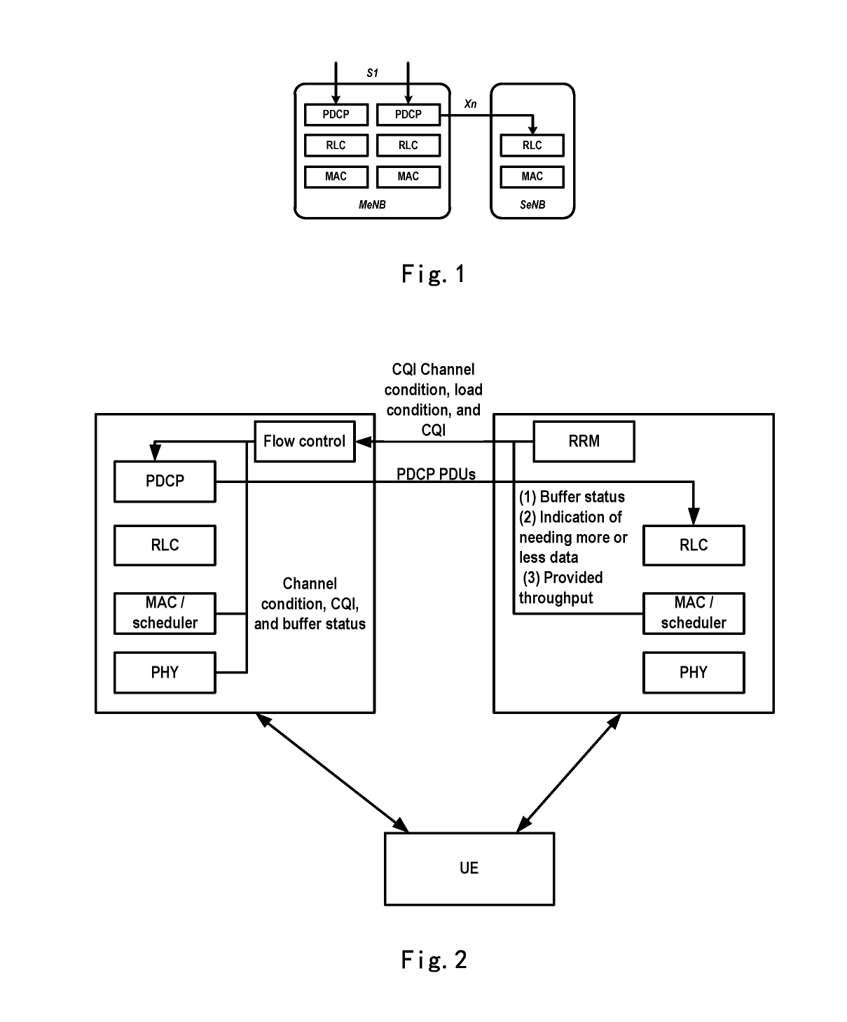

In the accompanying drawings, the same or similar reference numerals represent the same or similar components.

### DETAILED DESCRIPTION

Hereinafter, the principle and spirit of the present invention will be described with reference to several exemplary embodiments shown in the accompanying drawings. It should be understood that these embodiments are provided only for enabling those skilled in the art to better understand and then further implement the present invention, not intended to limit the scope of the present invention in any manner.

It should be noted that the following exemplary description mainly involves specifications used as non-limiting examples of exemplary network configurations and deployment. Specifically, a cellular communication network associated with LTE (including LTE-A) is used as a non-limiting example using dual-connectivity operations. Besides, the exemplary aspects provided here and the description of the embodiments specifically involve terms directly associated therewith. Such terms are only used in the background of the presented non-limiting examples and naturally will not limit the present invention in any manner. Actually, as long as they are compatible with the features described here, any other communication system, frequency band, network configuration or system deployment may also be utilized.

Hereinafter, various aspects, embodiments, and implementations of the present invention may be described using a plurality of alternatives. It should be noted that according to some needs and constraints, all described alternatives may be separately provided or provided in any conceivable combinations (also including combinations of individual features of various alternatives).

FIG. 2 shows a schematic diagram of a flow control system according to the embodiments of the present invention. As shown in FIG. 2, the flow control system comprises an MeNB and an SenB. For the sake of the brevity of description, the MeNB and the SeNB only perform radio bearer split for one RB. However, those skilled in the art should understand that the embodiments of the present invention will not be limited to one RB, which may be directed to a plurality of RBs or RB groups.

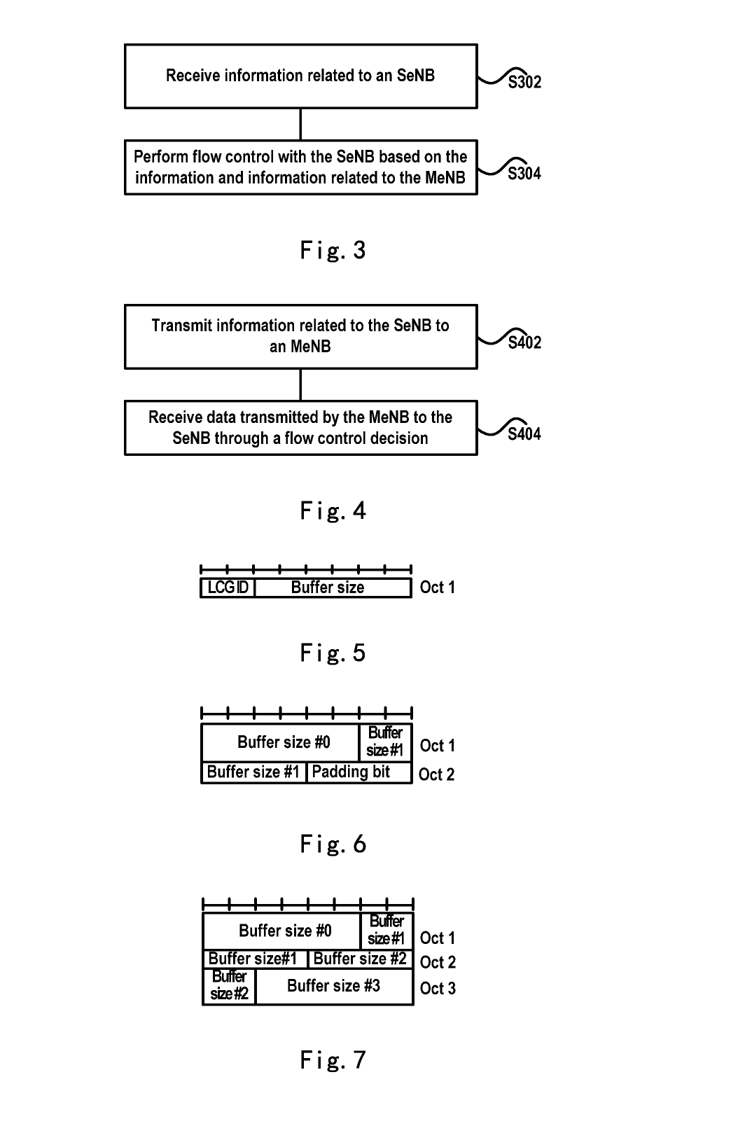

FIG. 3 shows a flow diagram of a flow control method for an MeNB supporting radio bearer split in a dual-connectivity system according to the embodiments of the present invention. As shown in FIG. 3, the method comprises step S302 and step S304 as follows:

Step S302: receiving information related to an SeNB.

Step S304: performing flow control with the SeNB based on the information and information related to the MeNB.

FIG. 4 shows a flow diagram of a flow control method for an SeNB supporting radio bearer split in a dual-connectivity system according to the embodiments of the present invention. As shown in FIG. 4, the method comprises steps S402 and S404 as follows:

Step S402: transmitting information related to the SeNB to an MeNB;

Step S404: receiving data transmitted by the MeNB to the SeNB through a flow control decision.

Through the embodiments of the present invention, the MeNB performs flow control between MeNB and SeNB based on information associated with the SeNB and the information associated with the MeNB. Flow control means determining how many data will be transmitted through MeNB and how many data will be transmitted through SeNB for a RB simultaneously transmitted between MeNB and SeNB. The flow control in the embodiment of the present invention can not only consider middle-and-long terms (such as channel conditions and load conditions) of two eNB, but also can be adapted to rapid change of the two eNBs.

It should be further noted here that when a flow control with SeNB is performed, the maximum buffer capacity of the SeNB (the information has been notified by the SeNB to the MeNB when establishing an Xn between the MeNB and the SeNB), such that the allocated data are no greater than the maximum buffer capacity.

According to various embodiments of the present invention, the information related to the SeNB is mainly divided into the following three groups:

(1) load condition, channel condition, and channel quality indicator (CQI) of the SeNB, which are used to facilitate the MeNB to achieve a basic flow control.

(2) buffer state of the SeNB, and the service state of the SeNB with respect to the RB or RB set supported between the MeNB and the SeNB, which are used for assisting the MeNB to know whether the SeNB services the RB or RB group as desired (as described in the flow control).

(3) the throughput provided in the SeNB to the RB or RB set supported between the MeNB and the SeNB.

Hereinafter, the above three groups of information, as well as how the MeNb correspondingly performs flow control between the MeNB and the SeNB based on the information, may be described in more detail with reference to FIG. 2, wherein the MeNB may create a PDCP PDU at the PDCP layer, and transmits, to the SeNB, the PDCP PDU transmitted by the SeNB for transmission based on the flow control result.

For group (1) information, the MeNB may receive, from the SeNB, the load condition (also including the load condition of the SeNB regarding the split RB of interest), channel condition (e.g., reference signal receiving power (RSRP)) and CQI of the SeNB, wherein the information may be collected and stored in a radio resource management (RRM) of the SeNB. Of course, those skilled in the art should understand that the information is not limited to be collected and stored in the RRM apparatus; in actual application, other manner may also be employed to obtain the information, e.g., directly obtaining the information from PHY or MAC. Besides, the MeNB may also receive, from the UE, the channel condition and CQI of the SeNB.

Additionally, the information may also be transmitted to the MeNB based on event trigger or time trigger.

For group (2) information, because MeNB and SeNB have two distributed schedulers, the MeNB cannot know how many data have been scheduled and transmitted in the SeNB. For example, the SeNB might not serve the RB or RB sets as expected (e.g., as described in the flow control). Even the MeNB also serves the traffic, the traffic on the RB might also suffer starvation or experience unfair scheduling treatment. Another possibility is that the SeNB serves the RB very well and the data are transmitted out. Therefore, for the above two scenarios, the SeNB should feed back the service/transmission state for the RB.

Therefore, according to the embodiments of the present invention and corresponding to the former in the group (2) information, the SeNB may feed back the buffer state for the buffer of the split RB or RB set of interest, for assisting the MeNB to know whether the SeNB serves the RB or RB set as expected (like described in flow control). Besides, the SeNB may periodically transmit a buffer state to the MeNB or transmits the buffer state to the MeNB when the data volume buffered in the buffer is lower than the preset first threshold or higher than the preset second threshold.

According to one embodiment of the present invention, the buffer status may assume the form of BSR (buffer size report). Specifically, if the buffer state indicates that the data volume buffered by the buffer is lower than the preset first threshold, it means the SeN may transmit data at a data rate higher than what is expected; therefore, the MeNB will increase the data volume allocated to the SeNB for transmission by the SeNB; or if the buffer state indicates that the data volume is higher than the preset second threshold, it means the SeNB may transmit data at a data rate lower than what is expected. In order to avoid storing more data in the SeNB buffer and delay the transmission, the MeNB should reduce the data volume allocated to the

SeNB for transmission by the SeNB or stop allocating, to the MeNB, the data volume for transmission by the SeNB.

For the BSR, the embodiments of the present invention may also improve it based on the number of RBs or RB sets supported between the MeNB and the SeNB, which will be described in detail below.

If only one radio bearer RB or RB set is supported between the MeNB and the SeNB, the buffer state will be transmitted to the MeNB using a 1-bit short BSR, wherein the short BSR includes a 2-bit LCG ID and a 6-bit buffer size corresponding to the RB or RB set, as shown in FIG. 5.

If more RBs or RB sets are supported between the MeNB and the SeNB, a long BSR is employed to transmit the buffer state to the MeNB, wherein the long BSR includes consecutively stored buffer sizes corresponding to the plurality of RBs or RB sets, respectively, and a padding bit at a tail part of the long BSR. For example, in the case that for 2 RBs, the buffer size corresponding to each RB is 6 bits, a 2-byte long BSR will be employed. In this way, the long BSR will include a buffize size of 2 RBs linked end-to-end (12 bits in total), and padding bits (4 bits in total), as shown in FIG. 6.

If four RBs or RB sets are supported between the MeNB and the SeNB, a 3-byte BSR will be employed to transmit a buffer state to the MeNB, wherein the 3-byte BSR comprises consecutively stored buffer sizes corresponding to the four RBs or RB sets, respectively. For example, in the case of 4 RBs, where the buffer size corresponding to each RB is 6 bits, a 3-byte long BSR will be employed. In this way, the long BSR will include a buffer size (24 bits in total) corresponding to 4 RBs linked end-to-end, as shown in FIG. 7.

Besides, according to the embodiments of the present invention, LCG ID or additional 1 bit may be employed to indicate whether to transmit the BSR. The BSR may also be transmitted to the SeNB using a periodical interval.

According to the embodiments of the present invention and corresponding to the latter in the group (2) information, the SeNB may further feed back the first indication information, which first indication information is for indicating the service state of the SeNb with respect to the RB or RB set supported between the MeNb and the SeNb. Specifically, if the service state indicates that the SeNB transmits data at a date rate higher than what is expected, then the MeNB increases the data volume allocated to the SeNB for transmission by the SeNB based on the first indication information; if the service state indicates that the SeNB transmits data at a data rate lower than what is expected, the MeNB reduces the data volume allocated to the SeNB for transmission by the SeNB or stopping allocating the data volume for transmission by the SeNB based on the first indication information.

Besides, the first indication information may be flagged simply by 1 bit or 2 bits, which are specifically described below.

In the case of flagging with 1 bit, for example, the first indication information indicates that the SeNB transmits data at a data rate higher than what is expected with the value “1,” such that the MeNB increases the data volume allocated to the SeNB for transmission by the SeNB based on the first indication information; with the value “0,” the first indication information indicates that the SeNB transmits data at a data rate lower than what is expected such that the MeNB reduces the data volume allocated to the SeNB for transmission by the SeNB based on the first indication information or stops allocating the SeNB the data volume for transmission by the SeNB, so as to avoid more data from being stored in the SeNB buffer and delaying the transmission. If the first indication information is not transmitted, it means the SeNB can work as expected and it needs no adjustment by the MeNB. Preferably, second indication information may also be adopted to indicate whether the first indication information exists, which second indication information is preferably 1 bit.

In the case of flagging with 2 bits, e.g., “00” means the SeNB can work as expected and it does not need adjustment in MeNB; “01” means the SeNB transmits data at a data rate higher than what is expected, such that the MeNB increases the data volume allocated to the SeNB for transmission by the SeNB based on the first indication information; “10” means the SeNB transmits data at a data rate lower than what is expected, such that the MeNB reduces the data volume allocated to the SeNb for transmission by the SeNB or stops allocating the SeNB the data volume to be transmitted by the SeNB, so as to avoid more data being stored in the SeNB buffer and delaying the transmission.

For group (3) information, i.e., the throughput in the SeNB provided to the RBs or RB sets supported between the MeNB and the SeNB. Particularly for the user with a slow mobility speed, the MeNB may also use the throughput as a reference for the final flow control.

According to various embodiments of the present invention, the information associated with the MeNB may comprise a load condition, channel condition, CQI, and buffer state of the MeNB, wherein the MeNB may collect the load condition and/or buffer state of the MeNB collected by the MeNB itself, and/or may receive channel condition and/or CQI of the MeNB from the UE.

According to the embodiments of the present invention, there is further provided a flow control device for an MeNB supporting radio bearer split in a dual-connectivity system, comprising a receiving module configured to receive information related to an SeNB; and a performing module configured to perform flow control with the SeNB based on the information and information related to the MeNB.

In one embodiment, the receiving module may receive information for performing basic flow control to the SeNB. Specifically, the receiving module may receive, from the SeNB, at least one of load condition (also including the load condition of the SeNB with respect to the split RB of interest), channel condition (e.g., reference signal receiving power (RSRP)), and CQI of the SeNB from the SeNB, and/or may receive channel condition and/or CQI of the SeNB from a UE.

In another embodiment, the receiving module may also receive the buffer state of the buffer of the SeNB with respect to the split RB or RB set of interest. The performing module increases, decreases, or stops allocating the SeNB the data volume for transmission by the SeNB based on the buffer state.

In a further embodiment, the receiving module further receives first indication information, wherein the indication information is for indicating a service state of the SeNB with respect to the split wireless bearer RB or RB set supported between the MeNB and the SeNB. In this embodiment, the receiving module further receives second indication information, wherein the second indication information is for indicating whether the first indication information is present, wherein the first indication and the second indication are both 1 bit; or, the first indication information is 2 bits, for indicating at least one of increasing the data volume allocated to the SeNB for transmission by the SeNB, reducing the data volume allocated to the SeNB for transmission by the SeNB, and stopping allocating the SeNB the data volume for transmission by the SeNB, and not adjusting the data volume allocated to the SeNB for transmission by the SeNB. In this embodiment, if the service state indicates that the SeNB transmits data at a data rate higher than what is expected, then the performing module increases the data volume allocated to the SeNB for transmission by the SeNB, then the performing module increases the data volume allocated to the SeNB for transmission by the SeNB or stopping allocating the data volume to the SeNB for transmission by the SeNB based on the first indication information.

In a further embodiment, the receiving module may further receive the throughput in the SeNB provided for the split radio bearer RB or RB set supported between the MeNB and the SeNB. The performing module allocates the SeNB the data for transmission by the SeNB based on the information and the throughput.

According to the embodiments of the present invention, there is further provided a flow control device for a SeNB supporting radio bearer split in the dual-connectivity system, comprising: a transmitting module configured to transmit information related to the SeNB to an MeNB; and a receiving module configured to receive data transmitted by the MeNB to the SeNB through a flow control decision.

According to one embodiment, the transmitting module may transmit, to the MeNB, information for performing basic flow control to the SeNB, wherein the information for performing basic flow control to the SeNB includes: at least one of load condition, channel condition, and channel condition indicator CQI of the SeNB.

In another embodiment, the transmitting module may transmit, to the MeNB, a buffer state of a buffer of the SeNB with respect to a RB or RB set of interest. In this embodiment, the transmitting module periodically transmit, to the MeNB, or transmit, to the MeNB, a buffer state when the data volume buffered by the buffer is lower than a preset first threshold or higher than a preset second threshold.

In a further embodiment, the transmitting module may transmit first indication information to the MeNB, wherein the first indication information is for indicating a service state of the SeNB with respect to a RB or RB set supported between the MeNB and the SeNB. In this embodiment, the transmitting module may further transmit second indication information to the MeNB, wherein the second indication information is for indicating whether the first indication information exists.

In one embodiment, both of the first indication information and the second indication information are 1 bit.

In one embodiment, the first indication information is 2 bits, for indicating at least one of increasing the data volume allocated to the SeNB for transmission by the SeNB, reducing the data volume allocated to the SeNB for transmission by the SeNB, stopping allocating the data volume for transmission by the SeNB, and not adjusting the data volume allocated to the SeNB for transmission by the SeNB.

In a further embodiment, if the service state indicates the SeNB transmits data at a data rate higher than what is expected, performing flow control with the SeNB based on the information and information related to the MeNB comprises: increasing the data volume allocated to the SeNB for transmission by the SeNB based on the first indication information; if the service state indicates the SeNB transmits data at a data rate lower than what is expected, performing flow control with the SeNB based on the information and information related to the MeNB comprises: reducing the data volume allocated to the SeNB for transmission by the SeNB or stopping allocating the data volume for transmission by the SeNB based on the first indication information.

In one embodiment, the information related to the MeNB includes: at least one of load condition and/or buffer state of the MeNB collected by the MeNB itself; and/or channel condition and/or CQI of the MeNB received by the MeNB from the UE.

In a further embodiment, the transmitting module may further transmit, to the MeNB, the throughput in the SeNB provided for the RB or RB set supported between the MeNB and the SeNB.

In view of the above, according to the embodiments of the present invention, there is provided an effective flow control solution and its relevant signaling transmission so as to support the user plane architecture 3C in the dual connectivity system. Through the embodiments of the present invention, the flow control not only considers performing flow control according to middle-and-long terms channel and load conditions, but also cause the flow control to consider the rapid change of the channel and load through feeding back the transmission/service state.

Besides, although the operations according to the method of the present invention are described in a particular sequence in the drawings, it does not require or suggest that these operations must be performed according to a specific sequence, or achieve the desired result after all of the illustrated operations have been performed. On the contrary, the steps depicted in the flow diagrams may change the performance sequence. Additionally or alternatively, some steps may be omitted; a plurality of steps may be merged into one step for execution, and/or a step may be decomposed into a plurality of steps for execution.

Although the present invention has been described with reference to several preferred embodiments, it should be understood that the present invention is not limited to the disclosed preferred embodiments. The present invention intends to cover various modifications and equivalent arrangements included within the spirit and scope of the appended claims. The scope of the appended claims conform to the broadest explanations, thereby covering all such modifications and functions.

1. A flow control method for a Master Evolved NodeB (MeNB) supporting radio bearer split in a dual-connectivity system, comprising:
receiving information related to an Secondary Evolved NodeB (SeNB); and
performing flow control with the SeNB based on the information and information related to the MeNB.

2. The method according to claim 1, wherein receiving information related to the SeNB comprises:
receiving information for performing basic flow control to the SeNB.

3. The method according to claim 2, wherein receiving information for performing basic flow control to the SeNB comprises:
receiving at least one of load condition, channel condition, and CQI of the SeNB from the SeNB, and/or
receiving channel condition and/or CQI of the SeNB from a UE.

4.-6. (canceled)

7. The method according to claim 2, wherein receiving information related to an SeNB further comprises:
receiving a buffer state of a buffer of the SeNB with respect to a RB or RB set of interest.

8. (canceled)

9. The method according to claim 2, wherein receiving information related to an SeNB further comprises:
receiving first indication information, wherein the first indication information is for indicating a service state of the SeNB for a RB or RB set of a split supported between the MeNB and the SeNB.

10.-13. (canceled)

14. The method according to claim 2, wherein receiving information related to the SeNB further comprises:
receiving a throughput in the SeNB provided by the RB or RB set supported between the MeNB and the SeNB.

15. (canceled)

16. The method according to claim 2, wherein the information related to the MeNB includes:
load condition and/or buffer state of the MeNB collected by the MeNB itself; and/or
channel condition and/or CQI of the MeNB received by the MeNB from the UE.

17. A flow control method for a Secondary Evolved NodeB (SeNB) supporting radio bearer split in the dual-connectivity system, comprising:
transmitting information related to the SeNB to an Master Evolved NodeB (MeNB); and
receiving data transmitted by the MeNB to the SeNB through a flow control decision.

18. The method according to claim 17, wherein transmitting information related to the SeNB to an MeNB comprises:
transmitting, to the MeNB, information for performing basic flow control to the SeNB.

19. The method according to claim 18, wherein the information for performing basic flow control to the SeNB includes:
at least one of load condition, channel condition, and channel condition indicator CQI of the SeNB.

20. (canceled)

21. The method according to claim 18, wherein transmitting information related to the SeNB to an MeNB further comprises:
transmitting, to the MeNB, a buffer state of a buffer of the SeNB with respect to a RB or RB set of interest.

22.-28. (canceled)

29. The method according to claim 18, wherein transmitting information related to the SeNB to an MeNB further comprises:
transmitting first indication information to the MeNB, wherein the first indication information is for indicating a service state of the SeNB with respect to a RB or RB set supported between the MeNB and the SeNB.

30.-32. (canceled)

33. The method according to claim 18, wherein transmitting information related to an SeNB further comprises:
transmitting, to the MeNB, a throughput in the SeNB provided by the RB or RB set supported between the MeNB and the SeNB.

34. A flow control device of an Master Evolved NodeB (MeNB) supporting radio bearer split in a dual connectivity system, comprising:
a receiving module configured to receive information related to an Secondary Evolved NodeB (SeNB); and
a performing module configured to perform flow control with the SeNB based on the information and information related to the MeNB.

35.-39. (canceled)

40. A flow control device for a Secondary Evolved NodeB (SeNB) supporting radio bearer split in the dual-connectivity system, comprising:
a transmitting module configured to transmit information related to the SeNB to an Master Evolved NodeB (MeNB); and
a receiving module configured to receive data transmitted by the MeNB to the SeNB through a flow control decision.
